(19) United States
(12) Patent Application Publication
(10) Pub. No.: US 2004/0044864 A1
(43) Pub. Date: Mar. 4, 2004

(54) Data storage

(76) Inventor: Joseph S. Cavallo, Framingham, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/233,082

(22) Filed: Aug. 30, 2002

(51) Int. Cl. G06F 12/16; G06F 12/00

(52) U.S. Cl. 711/162; 711/114

(57) ABSTRACT

In one embodiment, a method is provided. The method of this embodiment may include entering one mode of operation of first circuitry. In accordance with this one mode of operation, if an input/output (I/O) request is received by the first circuitry when the first circuitry is the one mode of operation, the first circuitry prevents the I/O request from being executed and stores the I/O request for future execution. The method of this embodiment may also include entering another mode of operation of the first circuitry. In this another mode of operation, the first circuitry may permit data stored in first storage associated with the first circuitry to be copied to second storage. The entry of the first circuitry into the another mode of operation may be based, at least in part, upon a determination by the first circuitry of whether second circuitry associated with third storage is ready to permit data stored in the third storage to be copied to the second storage. Of course, many variations, modifications, and alternatives are possible without departing from this embodiment.

### FIELD

This disclosure relates to the field of data storage.

### BACKGROUND

In a data backup technique, a redundant copy of data stored in a data storage system may be made. In the event that data stored in the system becomes lost and/or corrupted, it may be possible to recover the lost and/or corrupted data from the redundant copy. Unless the data backup technique is capable of copying the system's data to the redundant copy in a way that maintains the coherency of the system's data in the redundant copy, it may not be possible to recover meaningful data from the redundant copy.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 is a diagram illustrating a system embodiment.

FIG. 2 is a diagram illustrating information that may be encoded on a tape data storage medium according to one embodiment.

FIG. 3 is a diagram illustrating data volumes and data segments that may be stored in mass storage according to one embodiment.

FIG. 4 is a flowchart illustrating operations that may be performed in the system of FIG. 1 according to one embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

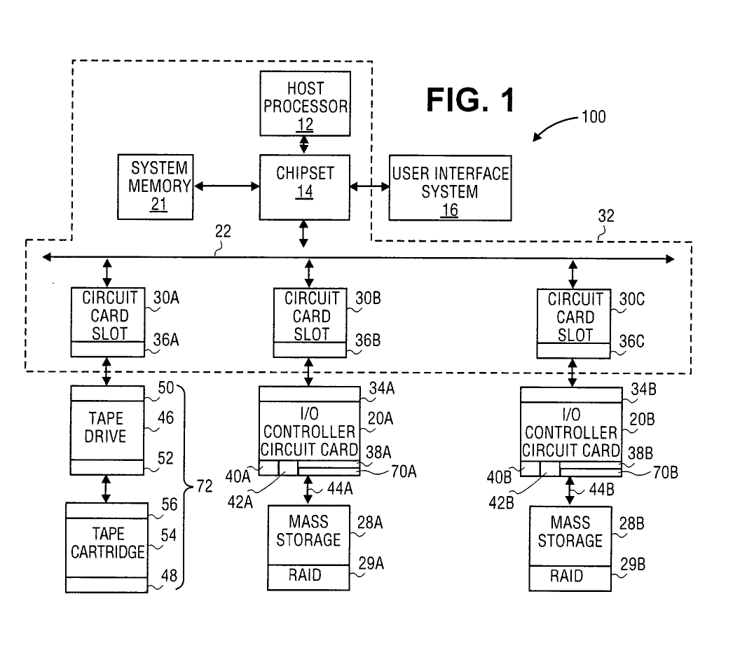

FIG. 1 illustrates a system embodiment 100. System 100 may include a host processor 12 coupled to a chipset 14. Host processor 12 may comprise, for example, an Intel® Pentium® III or IV microprocessor commercially available from the Assignee of the subject application. Of course, alternatively, host processor 12 may comprise another type of microprocessor, such as, for example, a microprocessor that is manufactured and/or commercially available from a source other than the Assignee of the subject application, without departing from this embodiment.

Chipset 14 may comprise a host bridge/hub system (not shown) that may couple host processor 12, a system memory 21 and a user interface system 16 to each other and to a bus system 22. Chipset 14 may also include an input/output (I/O) bridge/hub system (not shown) that may couple the host bridge/bus system to bus 22. Chipset 14 may comprise integrated circuit chips, such as those selected from integrated circuit chipsets commercially available from the Assignee of the subject application (e.g., graphics memory and I/O controller hub chipsets), although other integrated circuit chips may also, or alternatively be used, without departing from this embodiment. Additionally, chipset 14 may include an interrupt controller (not shown) that may be coupled, via one or more interrupt signal lines (not shown), to other components, such as, e.g., I/O controller circuit card 20A, I/O controller card 20B, and/or one or more tape drives (collectively and/or singly referred to herein as “tape drive 46”), when card 20A, card 20B, and/or tape drive 46 are inserted into circuit card bus extension slots 30B, 30C, and 30A, respectively. This interrupt controller may process interrupts that it may receive via these interrupt signal lines from the other components in system 100.

The operative circuitry 42A and 42B described herein as being comprised in cards 20A and 20B, respectively, need not be comprised in cards 20A and 20B, but instead, without departing from this embodiment, may be comprised in other structures, systems, and/or devices that may be, for example, comprised in motherboard 32, coupled to bus 22, and exchange data and/or commands with other components in system 100. User interface system 16 may comprise, e.g., a keyboard, pointing device, and display system that may permit a human user to input commands to, and monitor the operation of, system 100.

Bus 22 may comprise a bus that complies with the Peripheral Component Interconnect (PCI) Local Bus Specification, Revision 2.2, Dec. 18, 1998 available from the PCI Special Interest Group, Portland, Oreg., U.S.A. (hereinafter referred to as a “PCI bus”). Alternatively, bus 22 instead may comprise a bus that complies with the PCI-X Specification Rev. 1.0a, Jul. 24, 2000, available from the aforesaid PCI Special Interest Group, Portland, Oreg., U.S.A. (hereinafter referred to as a “PCI-X bus”). Also alternatively, bus 22 may comprise other types and configurations of bus systems, without departing from this embodiment.

I/O controller card 20A may be coupled to and control the operation of a set of one or more magnetic disk, optical disk, solid-state, and/or semiconductor mass storage devices (hereinafter collectively or singly referred to as “mass storage 28A”). In this embodiment, mass storage 28A may comprise, e.g., a mass storage subsystem comprising one or more redundant arrays of inexpensive disk (RAID) mass storage devices 29A.

I/O controller card 20B may be coupled to and control the operation of a set of one or more magnetic disk, optical disk, solid-state, and/or semiconductor mass storage devices (hereinafter collectively or singly referred to as “mass storage 28B”). In this embodiment, mass storage 28B may comprise, e.g., a mass storage subsystem comprising one or more redundant arrays of inexpensive disk (RAID) mass storage devices 29B.

Processor 12, system memory 21, chipset 14, PCI bus 22, and circuit card slots 30A, 30B, and 30C may be comprised in a single circuit board, such as, for example, a system motherboard 32. Mass storage 28A and/or mass storage 28B may be comprised in one or more respective enclosures that may be separate from the enclosure in which motherboard 32 and the components comprised in motherboard 32 are enclosed.

Depending upon the particular configuration and operational characteristics of mass storage 28A and mass storage 28B, I/O controller cards 20A and 20B may be coupled to mass storage 28A and mass storage 28B, respectively, via one or more respective network communication links or media 44A and 44B. Cards 20A and 20B may exchange data and/or commands with mass storage 28A and mass storage 28B, respectively, via links 44A and 44B, respectively, using any one of a variety of different communication protocols, e.g., a Small Computer Systems Interface (SCSI), Fibre Channel (FC), Ethernet, Serial Advanced Technology Attachment (S-ATA), or Transmission Control Protocol/Internet Protocol (TCP/IP) communication protocol. Of course, alternatively, I/O controller cards 20A and 20B may exchange data and/or commands with mass storage 28A and mass storage 28B, respectively, using other communication protocols, without departing from this embodiment.

In accordance with this embodiment, a SCSI protocol that may be used by controller cards 20A and 20B to exchange data and/or commands with mass storage 28A and 28B, respectively, may comply or be compatible with the interface/protocol described in American National Standards Institute (ANSI) Small Computer Systems Interface-2 (SCSI-2) ANSI X3.131-1994 Specification. If a FC protocol is used by controller cards 20A and 20B to exchange data and/or commands with mass storage 28A and 28B, respectively, it may comply or be compatible with the interface/protocol described in ANSI Standard Fibre Channel (FC) Physical and Signaling Interface-3 X3.303:1998 Specification. Alternatively, if an Ethernet protocol is used by controller cards 20A and 20B to exchange data and/or commands with mass storage 28A and 28B, respectively, it may comply or be compatible with the protocol described in Institute of Electrical and Electronics Engineers, Inc. (IEEE) Std. 802.3, 2000 Edition, published on Oct. 20, 2000. Further, alternatively, if a S-ATA protocol is used by controller cards 20A and 20B to exchange data and/or commands with mass storage 28A and 28B, respectively, it may comply or be compatible with the protocol described in “Serial ATA: High Speed Serialized AT Attachment,” Revision 1.0, published on Aug. 29, 2001 by the Serial ATA Working Group. Also, alternatively, if TCP/IP is used by controller cards 20A and 20B to exchange data and/or commands with mass storage 28A and 28B, respectively, it may comply or be compatible with the protocols described in Internet Engineering Task Force (IETF) Request For Comments (RFC) 791 and 793, published September 1981.

Circuit card slots 30A, 30B, and 30C may comprise respective PCI expansion slots that may comprise respective PCI bus connectors 36A, 36B, and 36C. Connectors 36A, 36B, and 36C may be electrically and mechanically mated with PCI bus connectors 50, 34A, and 34B that may be comprised in tape drive 46, card 20A, and card 20B, respectively. Circuit cards 20A and 20B also may comprise respective operative circuitry 42A and 42B. Circuitry 42A may comprise a respective processor (e.g., an Intel® Pentium® III or IV microprocessor) and respective associated computer-readable memory (collectively and/or singly referred to hereinafter as “processor 40A”). Circuitry 42B may comprise a respective processor (e.g., an Intel® Pentium® III or IV microprocessor) and respective associated computer-readable memory (collectively and/or singly referred to hereinafter as “processor 40B”). The respective associated computer-readable memory that may be comprised in processors 40A and 40B may comprise one or more of the following types of memories: semiconductor firmware memory, programmable memory, non-volatile memory, read only memory, electrically programmable memory, random access memory, flash memory, magnetic disk memory, and/or optical disk memory. Either additionally or alternatively, such computer-readable memory may comprise other and/or later-developed types of computer-readable memory. Also either additionally or alternatively, processors 40A and 40B each may comprise another type of microprocessor, such as, for example, a microprocessor that is manufactured and/or commercially available from a source other than the Assignee of the subject application, without departing from this embodiment.

Respective sets of machine-readable firmware program instructions may be stored in the respective computer-readable memories associated with processors 40A and 40B. These respective sets of instructions may be accessed and executed by processors 40A and 40B, respectively. When executed by processors 40A and 40B, these respective sets of instructions may result in processors 40A and 40B performing the operations described herein as being performed by processors 40A and 40B.

Circuitry 42A and 42B may also comprise cache memory 38A and cache memory 38B, respectively. In this embodiment, cache memories 38A and 38B each may comprise one or more respective semiconductor memory devices. Alternatively or additionally, cache memories 38A and 38B each may comprise respective magnetic disk and/or optical disk memory. Processors 40A and 40B may be capable of exchanging data and/or commands with cache memories 38A and 38B, respectively, that may result in cache memories 38A and 38B, respectively, storing in and/or retrieving data from cache memories 38A and 38B, respectively, to facilitate, among other things, processors 40A and 40B carrying out their respective operations.

Tape drive 46 may include cabling (not shown) that couples the operative circuitry (not shown) of tape drive 46 to connector 50. Connector 50 may be electrically and mechanically coupled to connector 36A. When connectors 50 and 36A are so coupled to each other, the operative circuitry of tape drive 46 may become electrically coupled to bus 22. Alternatively, instead of comprising such cabling, tape drive 46 may comprise a circuit card that may include connector 50.

Tape drive 46 also may include a tape read/write mechanism 52 that may be constructed such that a mating portion 56 of a tape cartridge 54 may be inserted into mechanism 52. When mating portion 56 of cartridge 54 is properly inserted into mechanism 52, tape drive 46 may use mechanism 52 to read data from and/or write data to one or more tape data storage media 48 (also referenced herein in the singular as, for example, “tape medium 48”) comprised in cartridge 54, in the manner described hereinafter. Tape medium 48 may comprise, e.g., an optical and/or magnetic mass storage tape medium. When tape cartridge 54 is inserted into mechanism 52, cartridge 54 and tape drive 46 may comprise a backup mass storage subsystem 72.

Slots 30B and 30C are constructed to permit cards 20A and 20B to be inserted into slots 30B and 30C, respectively. When card 20A is properly inserted into slot 30B, connectors 34A and 36B become electrically and mechanically coupled to each other. When connectors 34A and 36B are so coupled to each other, circuitry 42A in card 20A may become electrically coupled to bus 22. When card 20B is properly inserted into slot 30C, connectors 34B and 36C become electrically and mechanically coupled to each other. When connectors 34B and 36C are so coupled to each other, circuitry 42B in card 20B may become electrically coupled to bus 22. When tape drive 46, circuitry 42A in card 20A, and circuitry 42B in card 20B are electrically coupled to bus 22, host processor 12 may exchange data and/or commands with tape drive 46, circuitry 42A in card 20A, and circuitry 42B in card 20B, via chipset 14 and bus 22, that may permit host processor 12 to monitor and control operation of tape drive 46, circuitry 42A in card 20A, and circuitry 42B in card 20B. For example, host processor 12 may generate and transmit to circuitry 42A and 42B in cards 20A and 20B, respectively, via chipset 14 and bus 22, I/O requests for execution by mass storage 28A and 28B, respectively. Circuitry 42A and 42B in cards 20A and 20B, respectively, may be capable of generating and providing to mass storage 28A and 28B, via links 44A and 44B, respectively, commands that, when received by mass storage 28A and 28B may result in execution of these I/O requests by mass storage 28A and 28B, respectively. These I/O requests, when executed by mass storage 28A and 28B, may result in, for example, reading of data from and/or writing of data to mass storage 28A and/or mass storage 28B.

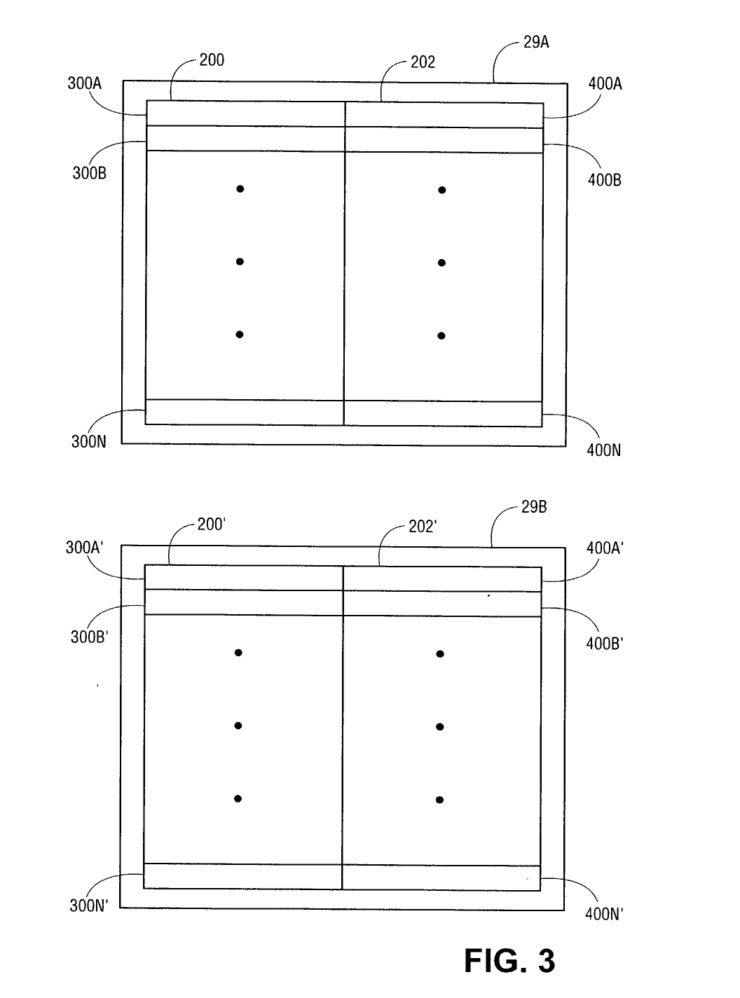

As shown in FIG. 3, RAID 29A may comprise a plurality of user data volumes 200 and 202. Of course, RAID 29A may comprise any number of user data volumes without departing from this embodiment. Each of the data volumes 200 and 202 may comprise a respective logical data volume that may span a respective set of physical disk devices (not shown) in mass storage 28A. For example, data volume 200 may comprise a plurality of logical user data segments 300A, 300B, . . . 300N, and data volume 202 may comprise a plurality of logical data segments 400A, 400B, . . . 400N. Depending upon the particular RAID technique implemented in RAID 29A, each respective logical data segment 300A, 300B, . . . 300N in volume 200 and each respective logical data segment 400A, 400B, . . . 400N in volume 202 may comprise a respective plurality of logically related physical data segments (not shown) that are distributed in multiple physical mass storage devices (not shown), and from which the respective logical data segment may be calculated and/or obtained. For example, if RAID Level 1 (i.e., mirroring) is implemented in RAID 29A, then each logical data segment 300A, 300B, . . . 300N in volume 200 and each logical data segment 400A, 400B, . . . 400N in volume 202 may comprise a respective pair of physical data segments (not shown) that are copies of each other and are distributed in two respective physical mass storage devices (not shown). Alternatively, other RAID techniques may be implemented in RAID 29A without departing from this embodiment. Each of the logical data segments in RAID 29A may have a predetermined size, such as, for example, 16 or 32 kilobytes (KB). Alternatively, or additionally, each of the logical data segments in RAID 29A may have predetermined size that corresponds to a predetermined number of disk stripes. Of course, the number and size of the logical data segments in RAID 29A may differ without departing from this embodiment.

The operations that may implement the RAID technique implemented in RAID 29A may be carried out by RAID circuitry (not shown) that may be comprised in, e.g., mass storage 28A. Alternatively, card 20A may comprise such RAID circuitry. Processor 40A may exchange data and/or commands with such RAID circuitry that may result in data segments being written to and/or read from RAID 29A in accordance with the RAID technique implemented by RAID 29A. Alternatively, processor 40A may be programmed to emulate operation of such RAID circuitry, and may exchange data and/or commands with mass storage 28A that may result in RAID 29A being implemented in mass storage 28A. Further alternatively, host processor 12 may be programmed to emulate operation of such RAID circuitry, and may exchange data and/or commands with mass storage 28A and/or processor 40A that may result in RAID 29A being implemented in mass storage 28A.

Also shown in FIG. 3, RAID 29B may comprise a plurality of user data volumes 200′ and 202′. Of course, RAID 29B may comprise any number of user data volumes without departing from this embodiment. Each of the data volumes 200′ and 202′ may comprise a respective logical data volume that may span a respective set of physical disk devices (not shown) in mass storage 28B. For example, data volume 200′ may comprise a plurality of logical user data segments 300A′, 300B′, . . . 300N′, and data volume 202′ may comprise a plurality of logical data segments 400A′, 400B′, . . . 400N′. Depending upon the particular RAID technique implemented in RAID 29B, each respective logical data segment 300A′, 300B′, . . . 300N′ in volume 200′ and each respective logical data segment 400A′, 400B′, . . . 400N′ in volume 202′ may comprise a respective plurality of logically related physical data segments (not shown) that are distributed in multiple physical mass storage devices (not shown), and from which the respective logical data segment may be calculated and/or obtained. For example, if RAID Level 1 (i.e., mirroring) is implemented in RAID 29B, then each logical data segment 300A′, 300B′, . . . 300N′ in volume 200′ and each logical data segment 400A′, 400B′, . . . 400N′ in volume 202′ may comprise a respective pair of physical data segments (not shown) that are copies of each other and are distributed in two respective physical mass storage devices (not shown). Alternatively, other RAID techniques may be implemented in RAID 29B without departing from this embodiment. Each of the logical data segments in RAID 29B may have a predetermined size, such as, for example, 16 or 32 kilobytes (KB). Alternatively, or additionally, each of the logical data segments in RAID 29B may have predetermined size that corresponds to a predetermined number of disk stripes. Of course, the number and size of the logical data segments in RAID 29B may differ without departing from this embodiment.

The operations that may implement the RAID technique implemented in RAID 29B may be carried out by RAID circuitry (not shown) that may be comprised in, e.g., mass storage 28B. Alternatively, card 20B may comprise such RAID circuitry. Processor 40B may exchange data and/or commands with such RAID circuitry that may result in data segments being written to and/or read from RAID 29B in accordance with the RAID technique implemented by RAID 29B. Alternatively, processor 40B may be programmed to emulate operation of such RAID circuitry, and may exchange data and/or commands with mass storage 28B that may result in RAID 29B being implemented in mass storage 28B. Further alternatively, host processor 12 may be programmed to emulate operation of such RAID circuitry, and may exchange data and/or commands with mass storage 28B and/or processor 40B that may result in RAID 29B being implemented in mass storage 28B.

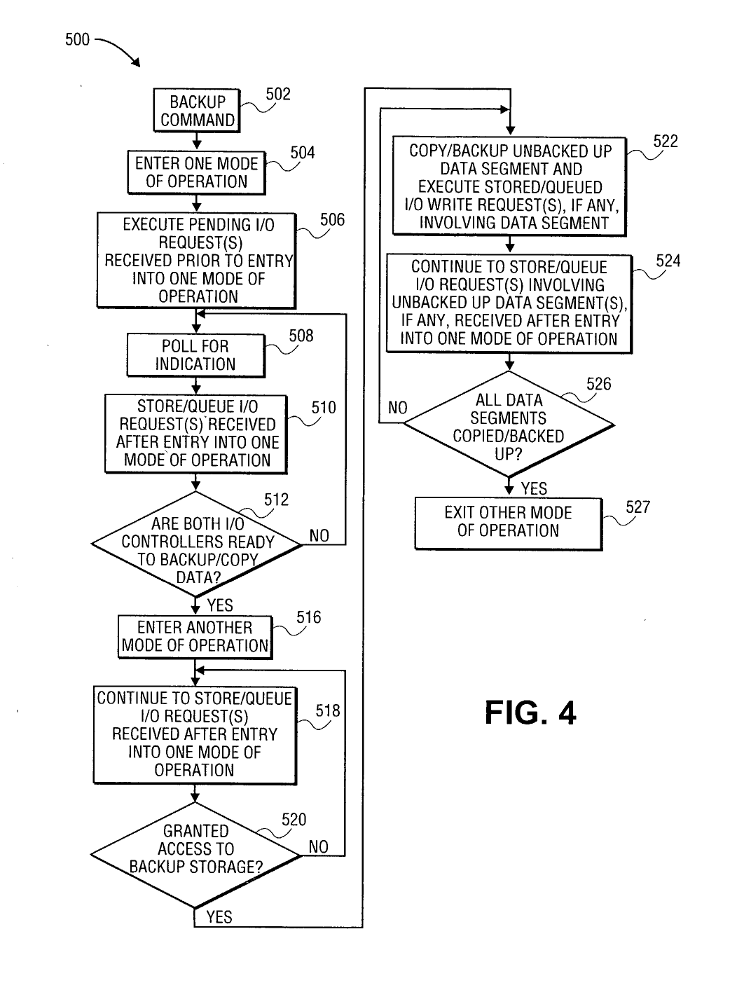

Firmware program instructions executed by processors 40A and 40B may result in, among other things, processors 40A and 40B issuing appropriate control signals to circuitry 42A and 42B in cards 20A and 20B, respectively, that may result in data storage, backup, and/or recovery operations, in accordance with one embodiment, being performed in system 100. FIG. 4 is a flowchart that illustrates operations 500 that may be carried out in system 100, in accordance with this embodiment.

In accordance with one embodiment, a human user (not shown) may issue a command to host processor 12 via user interface system 16 to create a redundant backup copy of data stored in RAID 29A and RAID 29B in mass storage 28A and mass storage 28B, respectively. This may result in host processor 12 generating and issuing to circuitry 42A and 42B in cards 20A and 20B, respectively, commands to initiate the creation of such a redundant backup copy.

As illustrated by operation 502 in FIG. 4, circuitry 42A in I/O controller card 20A may receive a command, issued from host processor 12, to initiate the creation of a redundant backup copy of data stored in RAID 29A in mass storage 28A. In response to receipt of this command from host processor 12, processor 40A may signal circuitry 42A. This may result in circuitry 42A in I/O controller card 20A entering one mode of operation, as illustrated by operation 504 in FIG. 4. In this one mode of operation, processor 40A may permit and/or initiate execution by mass storage 28A of all pending I/O requests (e.g., I/O write requests), if any, received prior to the entry of circuitry 42A in card 20A into the one mode of operation, that may result in modification of one or more of logical data segments in RAID 29A, as illustrated by operation 506 in FIG. 4. More specifically, in this one mode of operation, processor 40A may examine an I/O request queue (not shown) that may be maintained by processor 40A in, for example, cache memory 38A or the memory associated with processor 40A in card 20A, to determine whether any pending I/O requests, received prior to the entry of circuitry 42A in card 20A into the first mode of operation, that involve modifying data in one or more data segments in RAID 29A in mass storage 28A, are currently queued in the request queue for execution. As used herein, a “pending” I/O request is an I/O transaction of which a device assigned to perform, execute, and/or initiate the transaction has been informed, but whose performance, execution, and/or initiation has yet to be completed. If any such pending I/O requests are currently queued in the I/O request queue, processor 40A may signal circuitry 42A in card 20A. This may result in circuitry 42A issuing one or more commands via links 44A to mass storage 28A that may result in mass storage 28A executing all such pending I/O requests.

Also in this one mode of operation, processor 40A may signal circuitry 42A; this may result in circuitry 42A periodically polling for an indication that the other circuitry 42B is ready to begin copying to tape medium 48 a redundant backup copy of data stored in RAID 29B in mass storage 28B, as illustrated by operation 508 in FIG. 4. That is, in this one mode of operation, circuitry 42A in controller card 20A may periodically issue, via bus 22, a request to circuitry 42B in controller card 20B that circuitry 42B in controller card 20B provide to circuitry 42A an indication whether circuitry 42B in controller card 20B is ready to begin such copying. In response to such request, circuitry 42B may provide to circuitry 42A, via bus 22, a response that may indicate to circuitry 42A whether circuitry 42B is ready to begin such copying.

Alternatively, host processor 12 may periodically issue a request to circuitry 42B that circuitry 42B provide to host processor 12 an indication whether circuitry 42B is ready to begin such copying. In response to such request, circuitry 42B may provide to host processor 12 a response that may indicate whether circuitry 42B is ready to begin such copying. When host processor 12 receives from circuitry 42B an indication that circuitry 42B is ready to begin such copying, host processor 12 may provide circuitry 42A in controller card 20A with such indication.

Also in one mode of operation, circuitry 42A may store and/or queue for future execution any I/O requests (e.g., I/O write requests), received by circuitry 42A after entry of circuitry 42A into the one mode of operation, that if executed may result in modification of one or more logical data segments stored in RAID 29A in mass storage 28A, as illustrated by operation 510 in FIG. 4. For example, after the entry of circuitry 42A into the one mode of operation, host processor 12 may issue to circuitry 42A one or more I/O write requests that, if executed, may result in modification of one or more logical data segments in RAID 29A in mass storage 28A. If, while in the one mode of operation, circuitry 42A receives any such I/O write requests issued by host processor 12, processor 40A may signal circuitry 42A. This may result in circuitry 42A in card 20A storing and/or queuing such received I/O write request in the I/O request queue. This may also result in circuitry 42A being prevented from commanding, until after the one or more logical data segments that may modified by such received I/O write requests have been copied to tape medium 48, mass storage 28A to execute any such received I/O write requests from being executed by mass storage 28A. This may prevent mass storage 28A from executing any such received I/O request until after the one or more logical data segments that may modified by such received I/O write requests have been copied to tape medium 48.

Thus, after circuitry 42A enters this one mode of operation as a result of operation 504, and thereafter, while in this one mode of operation, operations 506, 508, and 510 may be performed. Also, while in this one mode of operation, processor 40A may periodically determine whether circuitry 42A and circuitry 42B are ready to copy the logical data segments in RAID 29A and RAID 29B, respectively, to tape medium 48, as illustrated by operation 512 in FIG. 4. Processor 40A may determine whether circuitry 42B is ready to copy to tape medium 48 the logical data segments in RAID 29B based, at least in part, upon whether circuitry 42A has received an indication generated, as a result, for example, at least in part, of operation 508, that circuitry 42B is ready to begin such copying.

In operation 512, processor 40A may also examine the I/O request queue stored in circuitry 42A to determine whether all of the pending I/O requests, if any, received prior to the entry of circuitry 42A into the one mode of operation, that if executed would result in modification of one or more of the logical data segments in RAID 29A, have been executed. After all of such pending I/O requests, if any, have been executed, processor 40A may determine that circuitry 42A is ready to begin copying to tape medium 48 a redundant backup copy of the data stored in RAID 29A.

If processor 40A determines, as a result of operation 512, that either or both of circuitry 42A and 42B are not ready to begin copying the logical data segments in RAID 29A and RAID 29B in mass storage 28A and 28B, respectively, to tape medium 48, processor 40A may signal circuitry 42A. If all of the pending I/O write requests, if any, received prior to the entry of circuitry 42A into the one mode of operation as a result of operation 504, that if executed would result in modification of one or more of the logical data segments in RAID 29A, have already been executed, for example, as a result of operation 506, this signaling of circuitry 42A by processor 40A may result in circuitry 42A remaining in the one mode of operation, with processing continuing with periodic executions of operations 508, 510, and 512, as illustrated in FIG. 4. Conversely, all of such I/O write requests, if any, have not already been executed, this signaling of circuitry 42A by processor 40A may result in circuitry 42A remaining in the one mode of operation, with processing continuing with execution of operation 506 and periodic execution of operations 508, 510, and 512.

Conversely, if processor 40A determines, as a result of operation 512, that both circuitry 42A and circuitry 42B are ready to begin copying the logical data segments in RAID 29A and RAID 29B in mass storage 28A and 28B, respectively, to tape medium 48, processor 40A may signal circuitry 42A. This may result in circuitry 42A in card 20A entering another mode of operation that is different from the mode of operation that circuitry 42A entered as a result of operation 504, as illustrated by operation 516. In this other mode of operation, circuitry 42A may continue to store and/or queue for future execution by mass storage 28A any I/O request that circuitry 42A may have received after entry of circuitry 42A into the one mode of operation and prior to operation 522, if the I/O request, if executed, would result in modification of a logical data segment stored in RAID 29A in mass storage 28A, as illustrated by operation 518 in FIG. 4. More specifically, as a result of operation 518, during this other mode of operation of circuitry 42A, any such received I/O request received may continue to be queued for future execution by mass storage 28A. Processor 40A may signal circuitry 42A; this may result in circuitry 42A being prevented from commanding, until after the logical data segment in RAID 29A that may be modified by execution of such received I/O request has been copied to tape medium 48 as a result of operation 522, mass storage 28A to execute any such received I/O request. This may result in mass storage 28A being prevented from executing any such received I/O request until after the logical data segment in RAID 29A that may be modified by execution of such received I/O request has been copied to tape medium 48 as a result of operation 522.

Also in this other mode of operation of circuitry 42A, processor 40A may signal circuitry 42A. This may result in circuitry 42A determining whether it has been granted access to tape medium 48 to copy the logical data segments stored in RAID 29A to tape medium 48, as illustrated by operation 520. For example, as a result of operation 520, circuitry 42A may use a conventional arbitration process to arbitrate with the other circuitry 42B for grant of such access to tape medium 48.

If the arbitration between circuitry 42A and 42B results in the grant of such access to circuitry 42A, then circuitry 42A may determine, as a result of operation 520, that circuitry 42A has been granted access to tape medium 48 to begin copying the logical data segments in RAID 29A to tape medium 48. Conversely, if this arbitration results in the grant of such access to circuitry 42B, then circuitry 42B may begin to copy the logical data segments in RAID 29B to tape medium 48. While circuitry 42B is copying these logical data segments to tape medium 48, circuitry 42A may continue to perform operation 518, and may periodically determine whether circuitry 42B has finished copying the logical data segments in RAID 29B to tape medium 48. That is, after circuitry 42B has finished copying the logical data segments in RAID 29B to tape medium 48, circuitry 42B may signal circuitry 42A to indicate same. Alternatively, after circuitry 42B has finished copying the logical data segments in RAID 29B to tape medium 48, circuitry 42B may signal host processor 12 to indicate same, and host processor 12 may signal circuitry 42A. In either case, this signaling of circuitry 42A by circuitry 42B or host processor 12 may result in circuitry 42A determining, as a result of operation 520, that circuitry 42A has been granted access to tape medium 48 to begin copying the logical data segments in RAID 29A to tape medium 48.

After circuitry 42A in card 20A has determined, as a result of operation 520, that it has been granted such access to tape medium 48, processor 40A may select a logical data segment from RAID 29A that has yet to be backed up (i.e., copied) to tape medium 48, and may signal tape drive 46 to copy this logical data segment to tape medium 48, as illustrated by operation 522 in FIG. 4. Processor 40A may make this selection based, at least in part, upon an examination of a bitmap 70A that may be stored in cache memory 38A in card 20A. That is, based upon signals provided to cache memory 38A from processor 40A, cache memory 38A may store and maintain bitmap 70A that may contain a sequence of bit values (not shown). Each of these bit values may correspond to and/or represent a respective logical data segment in RAID 29A. When circuitry 42A enters the other mode of operation as a result of operation 516, processor 40A may signal cache memory 38A to clear the bit values in bitmap 70A. Thereafter, after a respective logical data segment is transmitted to tape drive 46 for copying to tape medium 48, processor 40A may signal cache memory 38A to set the bit value in bitmap 70A that corresponds to the respective logical data segment. As used herein, a bit value is considered to be set when it is equal to a value that indicates a first Boolean logical condition (e.g., True), and conversely, a bit value is considered to be cleared when it is equal to a value that indicates a second Boolean logical condition (e.g., False) that is opposite to the first Boolean logical condition. Thus, by examining bitmap 70A in operation 522, processor 40A may determine which of the logical data segments in RAID 29A have yet to be copied to tape medium 48.

Based upon signals provided to cache memory 38B from processor 40B, cache memory 38B may store and maintain bitmap 70B that may contain a sequence of bit values (not shown) that may correspond to and/or represent respective logical data segments in RAID 29B. Bitmap 70B may be stored and/or maintained in cache memory 38B in a manner that is substantially similar to the above-described manner in which bitmap 70A may be stored and/or maintained.

Also in operation 522, processor 40A may examine the I/O request queue in card 20A to determine whether there are any pending I/O requests in the I/O request queue that, if executed, may result in modification of any of the logical data segments in RAID 29A. If any such pending I/O requests are in the I/O request queue, processor 40A may determine the logical data segment or segments that may be modified if such requests were executed, and any such segment or segments that have yet to be copied to tape medium 48 may be assigned higher relative priorities than other logical data segments in RAID 29A for selection by processor 40A for copying to tape medium 48. Processor 40A may select for copying to tape medium 48 logical data segments that are assigned a higher relative priorities before selecting for copying to tape medium logical data segments that are assigned lower relative priorities. Thus, processor 40A may also base its selection of which of the logical data segments to copy to tape 48, at least in part, upon these relative priorities that may be assigned by processor 40A to the logical data segments in RAID 29A.

In operation 522, after selecting a logical data segment (e.g., segment 300A) in RAID 29A to be copied to tape medium 48, processor 40A may permit the selected segment to be copied to tape medium 48. More specifically, processor 40A may signal circuitry 42A in card 20A. This may result in circuitry 42A signaling mass storage 28A. This may result in mass storage 28A retrieving selected logical data segment 300A from RAID 29A and supplying selected logical data segment 300A to circuitry 42A. Circuitry 42A then may transmit to tape drive 46 selected logical data segment 300A and information indicating the location of the segment 300A in RAID 29A. Circuitry 42A also may signal tape drive 46 to copy to tape medium 48 data segment 300A and the information that indicates the location of segment 300A in RAID 29A. As used herein, a “location” of data or a data segment may be, comprise, or be specified by, one or more identifiers, such as, for example, one or more logical and/or physical addresses, volumes, heads and/or sectors of and/or corresponding to the data or data segment, that may be used to identify the data or data segment for the purpose of enabling reading and/or modification of a data or data segment. Processor 40A then may signal cache 38A to set the bit value in bitmap 70A that corresponds to logical data segment 300A that was transmitted to tape drive 46.

After circuitry 42A has begun copying logical data segments in RAID 29A to tape medium 48 in this other mode of operation, if circuitry 42A receives an I/O request, processor 40A may examine the I/O request and bitmap 70A to determine whether the I/O request, if executed, may result in modification of a logical data segment in RAID 29A that has yet to be copied to tape medium 48. If processor 40A determines that the received I/O request, if executed, either would not result in modification of a logical data segment in RAID 29A or may result in modification of a logical data segment in RAID 29A that has been copied to tape medium 48, processor 40A may permit the received I/O request to be executed. Conversely, if processor 40A determines that the received I/O request, if executed, may result in modification of a logical data segment in RAID 29A that has yet to be copied to tape medium 48, processor 40A may signal circuitry 42A. This may result in circuitry 42A storing/queuing that I/O request in the I/O request queue in card 20A. This may also result in circuitry 42A being prevented from commanding mass storage 28A to execute the I/O request until after the segment has been copied to tape medium 48, as illustrated by operation 524 in FIG. 4. This may prevent mass storage 28A from executing the I/O request until after the segment has been copied to tape medium 48.

Also, as part of operation 524, processor 40A may examine the I/O requests, if any, queued in the I/O request queue in card 20A, and also may examine bitmap 70A to determine which, if any, of these I/O requests, if executed, may not result in modification of a logical data segment in RAID 29A or may result in modification of a logical data segment in RAID 29A that has been copied to tape medium 48. As part of operation 524, if processor 40A determines that any I/O requests are queued in the I/O request queue that, if executed, either would not result in modification of a logical data segment in RAID 29A or may result in modification of a logical data segment in RAID 29A that has been copied to tape medium 48, processor 40A may permit any such I/O requests to be executed.

In response to the transmission to tape drive 46 of segment 300A and the information indicating the location of the segment 300A in RAID 29A, and the signaling of tape drive 46 to copy same to tape medium 48, tape drive 46 may signal mechanism 52. This may result in mechanism 52 copying to tape medium 48 data segment 300A and the information. More specifically, mechanism 52 may copy the information and data segment 300A to tape medium 48 in such a way that the portion of tape medium 48 that may encode the information may be directly adjacent to the portion of tape medium 48 that may encode data segment 300A. The manner in which tape drive 46 may encode data from RAID 29A and RAID 29B on tape medium 48 will be described below.

After processor 40A signals cache 38A to set the bit value in bitmap 70A that corresponds to logical data segment 300A, processor 40A may examine bitmap 70A to determine whether all of the logical data segments in RAID 29A have been copied to tape medium 48, as illustrated by operation 526 in FIG. 4. If, as a result of operation 526, processor 40A determines that one or more logical data segments in RAID 29A have yet to be copied to tape medium 48, processing may loop back to operation 522, as illustrated in FIG. 4. Thereafter, operations 522, 524, and 526 may be repeated until all logical data segments in volumes 200 and 202 in RAID 29A have been copied to tape medium 48.

If, as a result of operation 526, processor 40A determines that all logical data segments in RAID 29A have been copied to tape medium 48, processor 40A may signal circuitry 42A. As illustrated by operation 527, this may result in circuitry 42A in card 20A exiting the other mode of operation that it entered as a result of operation 516. Thereafter, circuitry 42A in card 20A may re-enter a mode of operation that circuitry 42A was in prior to entering the one mode of operation as result of operation 504.

In this embodiment, in general, card 20B, processor 40B, circuitry 42B, cache memory 38B, mass storage 28B, and/or links 44B may perform respective operations that may correspond to operations 500, however, instead of being performed, in the manner previously described herein in connection with operations 500, by card 20A, processor 40A, circuitry 42A, cache memory 38A, mass storage 28A, and/or links 44A, these respective operations may be performed by card 20B, processor 40B, circuitry 42B, cache memory 38B, mass storage 28B, and/or links 44B, respectively. Also, in the respective subset of these respective operations that may correspond to operation 508, polling may be performed to obtain an indication whether circuitry 42A in card 20A is ready to begin copying logical data segments from RAID 29A to tape medium 48. Additionally, in the respective subset of these respective operations that may correspond to operation 520, circuitry 42B may arbitrate with circuitry 42A for access to tape medium 48 to begin copying logical data segments from RAID 29B to tape medium 48.

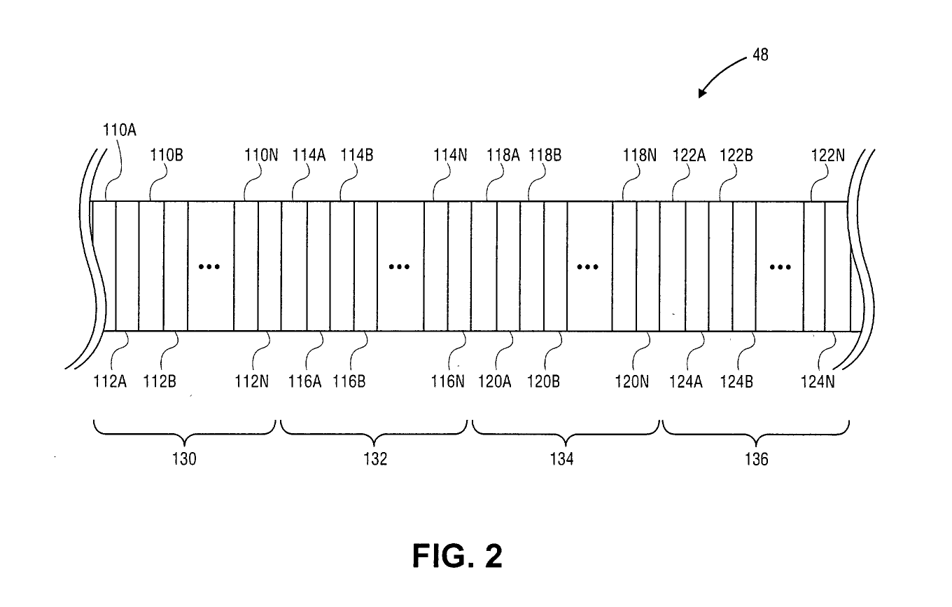

With particular reference now being made to FIG. 2, the manner in which tape drive 46 may encode data from RAID 29A and RAID 29B on tape medium 48 will be described. As shown in FIG. 2, after the logical data segments of RAID 29A and 29B have been encoded on tape medium 48 in accordance with one embodiment, tape medium 48 may include a plurality of portions 130, 132, 134, and 136 that encode logical data segments from RAID 29A and RAID 29B. For example, depending upon the direction in which mechanism 52 may advance tape medium 48 for the purpose of encoding data on tape medium 48, if as a result of the arbitration process between circuitry 42A and 42B in operation 520, circuitry 42A was granted access to tape medium 48 prior to circuitry 42B being granted access to tape medium 48, portions 130, 132, 134, and 136 may encode the logical data segments from volumes 200, 202, 200′, and 202′, respectively. In portion 130, encoded portions 110A, 110B, . . . 110N may encode copies of respective logical data segments from volume 200. Also in portion 130, encoded portions 112A, 112B, . . . 112N may encode respective information that may identify the respective locations of the respective logical data segments in volume 200 whose data may be encoded in portions 110A, 110B, . . . 110N. In portion 132, encoded portions 114A, 114B, . . . 114N may encode copies of respective logical data segments in volume 202. Also in portion 132, encoded portions 116A, 116B, . . . 116N may encode respective information that may identify the respective locations of the respective logical data segments from volume 202 whose data may be encoded in portions 114A, 114B, . . . 114N. In portion 134, encoded portions 118A, 118B, . . . 118N may encode copies of respective logical data segments in volume 200′. Also in portion 132, encoded portions 120A, 120B, . . . 120N may encode respective information that may identify the respective locations of the respective logical data segments from volume 200′ whose data may be encoded in portions 118A, 118B, . . . 118N. In portion 136, encoded portions 122A, 122B, . . . 122N may encode copies of respective logical data segments from volume 202′. Also in portion 136, encoded portions 124A, 124B, . . . 124N may encode respective information that may identify the respective locations of the respective logical data segments from volume 202′ whose data may be encoded in portions 122A, 122B, . . . 122N. Thus, according to one embodiment, portions 110A, 110B, . . . 110N, 114A, 114B, . . . 114N, 118A, 118B, . . . 118N, and 122A, 122B, . . . 122N of tape medium 48 that may encode copies of respective logical data segments from volumes 200, 202, 200′, and 202′, may be located adjacent portions 112A, 112B, . . . 112N, 116A, 116B, . . . 116N, 120A, 120B, . . . 120N, and 124A, 124B, . . . 124N of tape medium 48 that may encode respective information that may identify the respective locations of the respective logical data segments whose data is copied in portions 110A, 110B, . . . 110N, 114A, 114B, . . . 114N, 118A, 118B, . . . 118N, and 122A, 122B, . . . 122N, respectively. Of course, the particular order of portions 110A, 110B, . . . 110N, 114A, 114B, . . . 114N, 118A, 118B, . . . 118N, and 122A, 122B, . . . 122N relative to portions 112A, 112B, . . . 112N, 116A, 116B, . . . 116N, 120A, 120B, . . . 120N, and 124A, 124B, . . . 124N, and the particular order of portions 130, 132, 134, and 136 may vary without departing from this embodiment. Advantageously, since, in this embodiment, the respective copy of each respective logical data segment from RAID 29A and 29B is encoded on tape 48 adjacent to the respective information that identifies the respective location of that respective logical data segment, the logical data segments in RAID 29A and 29B may be copied, without loss of such information, to tape medium 48 in a sequence order that is independent of the respective locations of the logical data segments in RAID 29A and 29B.

Thus, in summary, in one system embodiment, first, second, and third storage subsystems are provided. A first circuit card also is provided that includes first circuitry capable of being coupled to the first and the third storage subsystems. Additionally, in this system embodiment, a second circuitry card is provided that includes second circuitry capable of being coupled to the second and to the third storage subsystems. When the first circuitry is coupled to the first storage subsystem and to the third storage subsystem, the first circuitry is capable of entering one mode of operation and another mode of operation. In the one mode of operation of the first circuitry, if an input/output (I/O) request is received by the first circuitry when the first circuitry is the one mode of operation, the first circuitry prevents the I/O request from being executed by the first storage subsystem and stores the I/O request for future execution by the first storage subsystem. In the other mode of operation, the first circuitry also is capable of entering another mode of operation in which the first circuitry permits data stored in the first storage subsystem to be copied to the third storage subsystem. The entry of the first circuitry into the another mode of operation may be based, at least in part, upon a determination by the first circuitry of whether second circuitry is ready to permit data stored in the second storage subsystem to be copied to the third storage subsystem. The third storage subsystem may include one or more media on which to copy the data stored in the first storage subsystem and the data stored in the second storage subsystem.

Advantageously, these features of this embodiment may permit, among other things, a coherent backup copy of data stored in at least the first storage subsystem to be made in the third storage subsystem, while at least the first circuitry may remain capable of receiving and storing for future execution a received I/O request, such as, for example, an I/O request from a host processor.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. For example, without departing from this embodiment, the respective numbers of I/O controller cards, tape drives, and/or mass storage may vary from the respective numbers thereof previously described herein as being comprised in system 100.

Also, for example, in mass storage 72, the one or more tape drives 46 may comprise a plurality of tape drives, and the one or more tape media 48 may comprise a plurality of tape media. One of these tape drives may encode onto one of these tape media data copied from mass storage 28A and/or RAID 29A, and another of these tape drives may encode onto another of these tape media data copied from mass storage 28B and/or RAID 29B.

Other modifications are also possible. Accordingly, the claims are intended to cover all such equivalents.

What is claimed is:

1. A method comprising:
entering one mode of operation of first circuitry in which, if an input/output (I/O) request is received by the first circuitry when the first circuitry is the one mode of operation, the first circuitry prevents the I/O request from being executed and stores the I/O request for future execution; and
entering another mode of operation of the first circuitry in which the first circuitry permits data stored in first storage associated with the first circuitry to be copied to second storage, entry of the first circuitry into the another mode of operation being based, at least in part, upon a determination by the first circuitry of whether second circuitry associated with third storage is ready to permit data stored in the third storage to be copied to the second storage, the second storage including one or more media on which to copy the data stored in the first storage and the data stored in the third storage.

2. The method of claim 1, wherein:
in the one mode of operation of the first circuitry, if another I/O request to be executed by the first circuitry was pending prior to entry of the first circuitry into the one mode of operation, the first circuitry permits the I/O request to be executed while the first circuitry is in the one mode of operation

3. The method of claim 1, wherein:
the first circuitry and the second circuitry comprise respective I/O controllers;
the first storage and third storage comprise respective sets of one or more mass storage devices; and
the second storage comprises a tape data storage device.

4. The method of claim 3, wherein:
the respective sets of mass storage devices comprise a redundant array of inexpensive disks (RAID).

5. The method of claim 1, further comprising:
receiving by the first circuitry, prior to entry of the first circuitry into the one mode of operation, at least one write request;
permitting, during the one mode of operation of the first circuitry, the at least one write request to be executed; and
basing the entry of the first circuitry into the another mode of operation, at least in part, upon whether the at least one write request has been executed.

6. The method of claim 1, wherein:
entry of the first circuitry into the one mode of operation is in response, at least in part, to receipt by the first circuitry of a command from a host processor; and
the determination by the first circuitry of whether the second circuitry is ready to permit the data stored in the third storage to be copied to the second storage is based, at least in part, upon whether the first circuitry has received an indication from at least one of third circuitry and the second circuitry.

7. The method of claim 6, wherein:
the third circuitry comprises a host processor.

8. An apparatus comprising:
first circuitry capable of entering one mode of operation in which, if an input/output (I/O) request is received by the first circuitry when the first circuitry is the one mode of operation, the first circuitry prevents the I/O request from being executed and stores the I/O request for future execution, the first circuitry also being capable of entering another mode of operation in which the first circuitry permits data stored in first storage associated with the first circuitry to be copied to second storage, entry of the first circuitry into the another mode of operation being based, at least in part, upon a determination by the first circuitry of whether second circuitry associated third storage is ready to permit data stored in the third storage to be copied to the second storage, the second storage including one or more media on which to copy the data stored in the first storage and the data stored in the third storage.

9. The apparatus of claim 8, wherein:
in the one mode of operation of the first circuitry, if another I/O request to be executed was pending prior to entry of the first circuitry into the one mode of operation, the first circuitry permits the I/O request to be executed while the first circuitry is in the one mode of operation

10. The apparatus of claim 8, wherein:
the first circuitry and the second circuitry comprise respective I/O controllers;
the first storage and third storage comprise respective sets of one or more mass storage devices; and
the second storage comprises a tape data storage device.

11. The apparatus of claim 10, wherein:
the respective sets of mass storage devices comprise a redundant array of inexpensive disks (RAID).

12. The apparatus of claim 8, wherein:
the first circuitry is capable of receiving, prior to entry of the first circuitry into the one mode of operation, at least one write request;
the first circuitry is also capable of permitting, during the one mode of operation of the first circuitry, the at least one write request to be executed; and
the entry of the first circuitry into the another mode of operation is based, at least in part, upon whether the at least one write request has been executed.

13. The apparatus of claim 8, wherein:
entry of the first circuitry into the one mode of operation is in response, at least in part, to receipt by the first circuitry of a command from a host processor; and
the determination by the first circuitry of whether the second circuitry is ready to permit the data stored in the third storage to be copied to the second storage is based, at least in part, upon whether the first circuitry has received an indication from at least one of third circuitry and the second circuitry.

14. The apparatus of claim 13, wherein:
the third circuitry comprises a host processor.

15. An article comprising:
a storage medium having stored thereon instructions that when executed by a machine result in the following:
entering one mode of operation of first circuitry in which, if an input/output (I/O) request is received by the first circuitry when the first circuitry is the one mode of operation, the first circuitry prevents the I/O request from being executed and stores the I/O request for future execution; and
entering of another mode of operation of the first circuitry in which the first circuitry permits data stored in first storage associated with the first circuitry to be copied to second storage, entry of the first circuitry into the another mode of operation being based, at least in part, upon a determination by the first circuitry of whether second circuitry associated with third storage is ready to permit data stored in the third storage to be copied to the second storage, the second storage including one or more media on which to copy the data stored in the first storage and the data stored in the third storage.

16. The article of claim 15, wherein:
in the one mode of operation of the first circuitry, if another I/O request to be executed was pending prior to entry of the first circuitry into the one mode of operation, the first circuitry permits the I/O request to be executed while the first circuitry is in the one mode of operation

17. The article of claim 15, wherein:
the first circuitry and the second circuitry comprise respective I/O controllers;
the first storage and third storage comprise respective sets of one or more mass storage devices; and
the second storage comprises a tape data storage device.

18. The article of claim 17, wherein:
the respective sets of mass storage devices comprise a redundant array of inexpensive disks (RAID).

19. The article of claim 15, wherein:
the instructions when executed by the machine also result in the following:
receiving, by the first circuitry, prior to entry of the first circuitry into the one mode of operation, of at least one write request;
permitting, during the one mode of operation of the first circuitry, of the at least one write request to be executed; and
basing of the entry of the first circuitry into the another mode of operation, at least in part, upon whether the at least one write request has been executed.

20. The article of claim 15, wherein:
entry of the first circuitry into the one mode of operation is in response, at least in part, to receipt by the first circuitry of a command from a host processor; and
the determination by the first circuitry of whether the second circuitry is ready to permit the data stored in the third storage to be copied to the second storage is based, at least in part, upon whether the first circuitry has received an indication from at least one of third circuitry and the second circuitry.

21. The article of claim 20, wherein:
the third circuitry comprises a host processor.

22. A system comprising:
a first storage subsystem, a second storage subsystem, and a third storage subsystem;
a first circuit card including first circuitry capable of being coupled to the first storage subsystem and to the third storage subsystem; and
a second circuitry card including second circuitry capable of being coupled to the second storage subsystem and to the third storage subsystem;
when the first circuitry is coupled to the first storage subsystem and the third storage subsystem, the first circuitry being capable of:
entering one mode of operation in which, if an input/output (I/O) request is received by the first circuitry when the first circuitry is the one mode of operation, the first circuitry prevents the I/O request from being executed by the first storage subsystem and stores the I/O request for future execution by the first storage subsystem; and
entering another mode of operation in which the first circuitry permits data stored in the first storage subsystem to be copied to the third storage subsystem, entry of the first circuitry into the another mode of operation being based, at least in part, upon a determination by the first circuitry of whether second circuitry is ready to permit data stored in the second storage subsystem to be copied to the third storage subsystem, the third storage subsystem including one or more media on which to copy the data stored in the first storage subsystem and the data stored in the second storage subsystem.

23. The system of claim 22, wherein:
the first storage subsystem, the second storage subsystem, and the third storage subsystem each comprise one or more respective mass storage devices; and
the first circuit card and the second circuit card each comprise a respective I/O controller.

24. The system of claim 22, wherein:
the first storage subsystem and the second storage subsystem each comprise a respective redundant array of inexpensive disks (RAID);
the third storage subsystem comprises a tape mass storage system; and
the first circuitry and the second circuitry each comprise a respective processor.

25. The system of claim 22, wherein:
the first circuitry and the second circuitry are capable of being coupled to the first storage subsystem and the second storage subsystem, respectively, via one or more respective communication links;
the first storage subsystem, the second storage subsystem, and the third storage subsystem are capable of storing a plurality of data segments; and
the first circuitry and the second circuitry each comprise respective cache memory to store one or more of the data segments.

26. The system of claim 22, further comprising:
a circuit board that comprises a bus and a host processor coupled to the bus; and
the first circuit card and the second circuit card are capable of being coupled to the bus.

27. The system of claim 22, wherein:
the third storage subsystem comprises a tape storage subsystem to store the data copied from the first storage subsystem and the second storage subsystem to one tape data storage medium.

28. The system of claim 27, wherein:
the data copied to the one tape data storage medium includes at least one respective data segment from each of the first storage subsystem and the second storage subsystem; and
the system also stores on the one tape storage medium information to identify each respective data segment copied to the one tape data storage medium.

29. The system of claim 22, wherein:
the I/O request, if executed, results in a modification of a data segment in the first storage subsystem; and
in the another mode of operation:
the first circuitry is capable of copying the data segment to the third storage subsystem; and
after the data segment has been copied to the third storage subsystem, the first circuitry is also capable of permitting the I/O request to be executed.
